(19) United States
(12) Patent Application Publication
(10) Pub. No.: US 2011/0039502 A1
(43) Pub. Date: Feb. 17, 2011

(54) MULTIPLE RESPONSE FILTERING APPARATUS

(76) Inventor: Paolo Marini, Capena (IT)

Correspondence Address: Hershkovitz & Associates, LLC, 2845 Duke Street, Alexandria, VA, 22314, US

(21) Appl. No.: 12/933,684

(22) PCT Filed: Mar. 20, 2009
(86) PCT No.: PCT/IT09/00106

§ 371 Date: Nov. 5, 2010

(30) Foreign Application Priority Data
Mar. 21, 2008 (IT) RM2008A000157

(51) Int. Cl. H04B 1/38

(52) U.S. Cl. 455/73

(57) ABSTRACT

A multiple response filtering apparatus having distribution means, with an inlet port and a plurality of outlet ports, suitable to distribute inlet signals on at least a first assembly of said outlet ports plurality and to further distribute signal arriving from said at least a first assembly on at least a second assembly of said plurality of outlet ports; a plurality of filtering units, having first and second terminals, each filtering unit being connected by said first terminals to a relevant assembly of outlet ports of said distribution means and suitable to carry out a filtering operation transmitting a spectrum band of a signal on said first terminals and on said second terminals and reflecting the remaining part of the spectrum, and vice versa; and combination means with a plurality of inlet ports connected with second terminals of said filtering units and an outlet port, said combination means being suitable to combine on said outlet port signal arriving from said second terminals of said filtering units.

The present invention relates to a multiple response filtering apparatus.

More specifically, the invention concerns an apparatus that can carry out filtering of a plurality of signals, both in a transmission mode and a reception mode, with a high selectivity, drastically limiting possible signal interference phenomenon's.

As it is well known, at present, filtering apparatuses are present in transmission or reception broadcast systems, to select a band and for transmission (reception of modulated signals from different channels.

Often it is necessary carrying out filtering (selection) operations within said band, so that said filtering apparatuses must provide high selectivity filters in the response (band) to be filtered.

This obviously also involves a high circuit complexity, with the consequent increase of loss of connection, the use of high quality components and thus increase of total costs of the above apparatuses.

Some technical problems will be described in the following relevant to the technical aspect as well as to the commercial aspect. A first problem is well known to transmitters manufacturers, often having the needing to filter two or more bands, each one centered on different central frequencies, of a spectrum of a signal arriving from a single generator or source (transmitting apparatus). This operation is today technically possible, but it involves a high power loss of filtered signals, of about 3 dB for two frequency bands to be filtered (therefore, if from a signal spectrum arriving from a single generator it is wished filtering three bands, three signals will have a power loss of 4.77 dB (10 log³) in best cases.

In order to prevent this power loss it would be today necessary providing a transmitter for each signal to be transmitted, but it would in any case involve high costs.

Moreover, taking into consideration a real needing, it would be suitable having a filtering system permitting a multiple response to provide a “broadcaster” to a transmitter, e.g. for digital audio (DAB), wherein a part of spectrum emitted can be assigned to a different user.

It is also felt the needing by exercise managers of the transmission system to be able to add to a system able combining a plurality of already existing transmitters (analogical and/or digital transmitters), one or more further (digital and/or analogical) transmitters often not defined with respect to their technical requirements, supplying the same irradiating system (antenna). This kind of needing derives from the needing of using an existing irradiating system for transmission of further signals, without necessarily converting the combination and filtering system of signals, or even making structural modifications to the same system.

A specific example of a field where this kind of technical problem is particularly present in the field of signal cable distribution field, also known as CATV (Community Antenna Television, i.e. cable television or subscription providing of TV services at home by a coaxial cable).

A further technical problem in the filtering system field, that is present in the signal reception side, by which telemetric data and other information are transmitted, in a densely used band, eventually even in the same site wherein receiver is placed, without:
reciprocal mixing phenomenon;
dynamic loss within receiver, being it impossible receiving and/or decoding signal (the latter phenomenon is very serious since it can involve a total loss of received information).

In view of the above, it is object of the present invention that of solving the above problems providing a multiple response filtering apparatus that can independently filter two or more bands from spectrum of the same signal without any meaningful power loss.

It is further object of the present invention that of suggesting a multiple response filtering apparatus that can selectively carry out operations on a single part of specific spectrum, by a reduced circuit complexity, thus also maintaining a low insertion loss in case of transmitting apparatuses or low signal—noise ratio for receiving systems/apparatuses.

It is therefore specific object of the present invention a multiple response filtering apparatus comprising distribution means, with an inlet port and a plurality of outlet ports, suitable to distribute inlet signals on at least a first assembly of said outlet ports plurality and to further distribute signal arriving from said at least a first assembly on at least a second assembly of said plurality of outlet ports; a plurality of filtering units, having first and second terminals, each filtering unit being connected by said first terminals to a relevant assembly of outlet ports of said distribution means and suitable to carry out a filtering operation transmitting a spectrum band of a signal on said first terminals and on said second terminals and reflecting the remaining part of the spectrum, and vice versa; and combination means with a plurality of inlet ports connected with second terminals of said filtering units and an outlet port, said combination means being suitable to combine on said outlet port signal arriving from said second terminals of said filtering units.

Always according to the invention, said combination means can comprise a further inlet port for a further signal of a wide band signal and said combination means combining said signal with said outlet signal.

Still according to the invention, said filtering means can be of the low-pass and/or band-pass and/or band-deletion and/or high-pass type.

Furthermore, according to the invention, said distribution means and said combination means can comprise one or more hybrid connections, each one of said connections being provided with a first, a second, a third and a fourth terminals, so that a signal entering within said first or said fourth terminal is distributed on said second and third terminal, while a third signal entering in said second or third terminal is distributed on said fourth or first terminal.

Preferably, according to the invention, said hybrid connections can be of the attenuation type with −3 dB and 90° phase-displacement.

Always according to the invention, said distribution means can comprise hybrid connections in a number corresponding to the number of filtering operations minus one and having a first and a last hybrid connection, so that: first terminal of said first hybrid connection is the inlet port of said apparatus; second and third terminal of each hybrid connection are both connected with a relevant filtering unit for each hybrid connection; and fourth terminal of said last hybrid connection is connected to a filtering unit, while fourth terminal is connected with first terminal of the following hybrid connection; said combination means can comprise a plurality of hybrid connections, in a number corresponding to the number of frequencies to be filtered minus one and having a further first and a further last hybrid connection, and collected in such a way that: fourth terminal of said further first hybrid connection is the outlet port of said apparatus; second and third terminals of each hybrid connection are both connected to a relevant filtering unit for each hybrid connection; and first terminal of said further last hybrid connection is connected with said filtering unit to which fourth terminal of said last hybrid connection of said distribution means is connected, while first terminal of each possible hybrid connection is connected to the fourth terminal of the following hybrid connection.

Still according to the invention, said filtering units connected to said second and third terminals of each hybrid connection of said distribution means comprise a pair of independent filters, each one connected with one of said terminals and both suitable to carry out the same filtering operation, while filtering unit connected to the fourth terminal of the past hybrid connection comprises a single filter.

Furthermore, according to the invention, said distribution means comprise one or more hybrid connections in a number corresponding to the number of filtering operations and having a first and a last hybrid connection, connected in such a way that: first terminal of said first hybrid connection is the inlet port of said apparatus; fourth terminal of said last hybrid connection is connected to a resistive load, while fourth terminal of each one of the possible hybrid connections is connected to the first terminal of the following hybrid connection; and second and third terminal of each hybrid connection are both connected to a relevant filtering unit for each hybrid connection; said combination means comprising two or more hybrid connections in a number corresponding to the number of filtering operations, having a further first and a further last hybrid connection, and collected so that: fourth terminal of said first hybrid connection is the outlet port of said apparatus; first terminal of said further last hybrid connection is said further inlet port for a further signal, to which it can be connected a resistive load in case it is not used, while first terminal of each hybrid connection is connected with the fourth terminal of the following hybrid connection, or with said further last hybrid connection in case two filtering operations are carried out; and second and third terminal of each hybrid connection are both connected with a relevant filtering unit for each hybrid connection.

Advantageously, according to the invention, each one of said filtering units can be connected with said second and third terminals of each hybrid connection of said distribution means, and comprises a pair of independent filters, each one connected with one of said terminals and both suitable to carry out the same filtering operation.

Preferably according to the invention said resistive load can be 50 ohm or 75 ohm.

Always according to the invention, said distribution means and said combination means can comprise circulator, each one provided with one first, a second and a third terminal placed consecutively each other.

Still according to the invention, said distribution means can comprise one or more circulator, in a number corresponding to the number of filtering operations minus one, and having a first and a last circulator, connected in such a way that: first terminal of said first circulator is the inlet port of said apparatus; second terminal of each circulator is connected to a relevant filtering unit; and third terminal of said last circulator, or of said first circulator in case of two filtering operations, is connected with a filtering unit, while third terminal of each other possible circulator is connected with first terminal of the following circulator; said combination means can comprise a plurality of circulator in a number corresponding to the number of filtering operation minus one comprising a further first and a further last circulator and connected in such a way that: first terminal of each one of said circulator is connected with a relevant filtering unit; second terminal of said further first circulator is the exit port of said apparatus, while second terminal of each other possible circulator is connected to the third terminal of the preceding circulator; third terminal of said further last circulator is connected to the exit of said filtering unit at the inlet of which it is connected third terminal of said last circulator of said distribution means.

Furthermore, according to the invention, said apparatus can comprise a combination circulator the first terminal of which is connected to the exit port of said apparatus and on third terminal being it possible connecting a further signal source, so that a signal is present on the relevant second terminal of said combination circulator, the frequency spectrum of which is combination of frequency spectrum of said signals arriving from said exit port of said apparatus and from said further source.

Always according to the invention, said filtering units can comprise a single filter.

Advantageously, according to the invention, said apparatus can be connected by optic fibers.

The present invention will be now described, for illustrative but not limitative purposes, according to its preferred embodiments, with particular reference to the figures of the enclosed drawings, wherein:

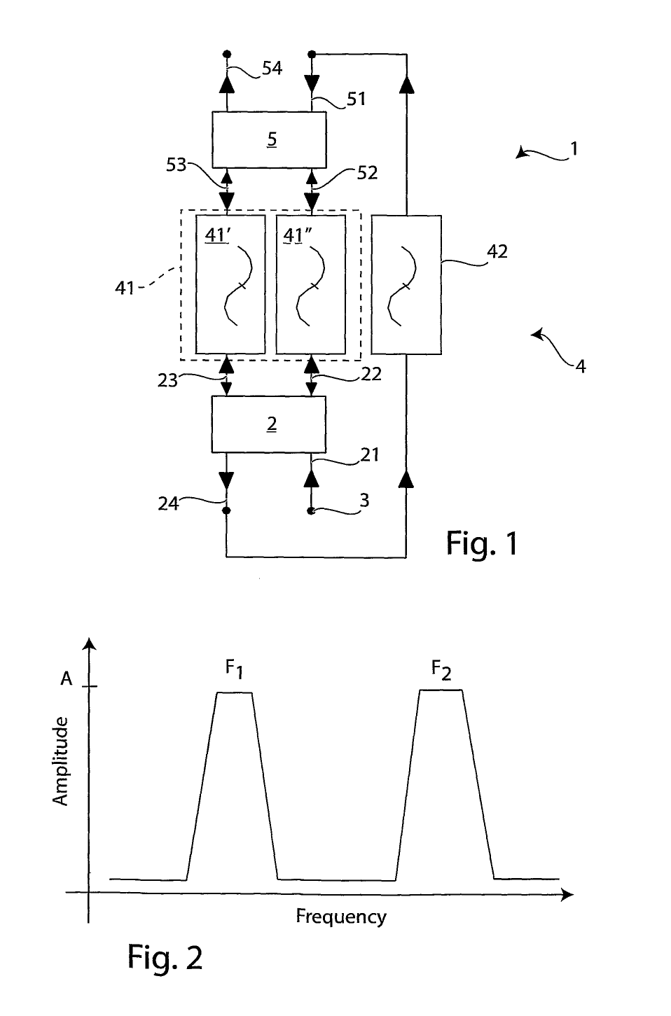

FIG. 1 shows a first embodiment of a double response filtering apparatus according to the invention for connection with a transmission system;

FIG. 2 shows graph of spectrum at the outlet of the filtering apparatus according to FIG. 1;

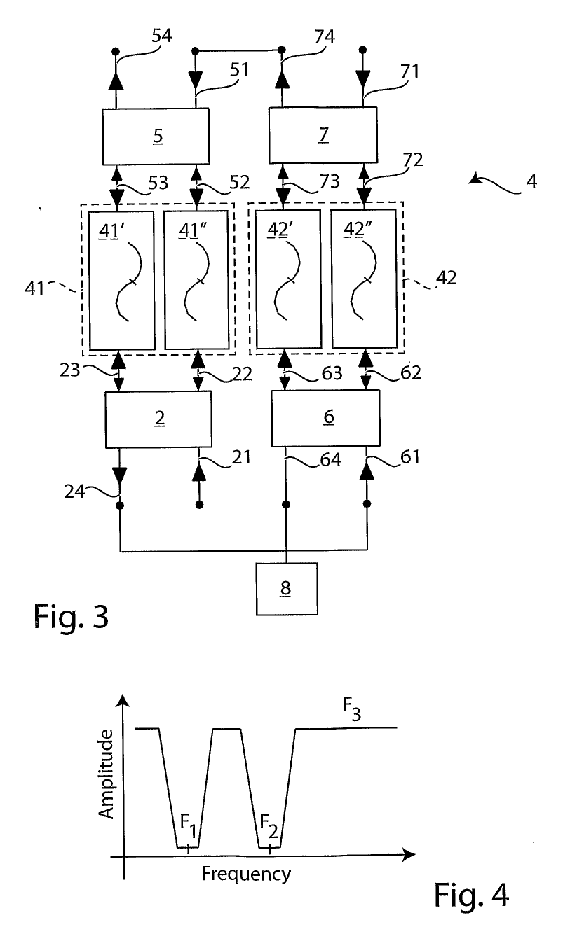

FIG. 3 shows a second embodiment of a filtering apparatus according to the invention;

FIG. 4 shows graph of the signal at the inlet port of the fourth connection of the filtering apparatus according to FIG. 3;

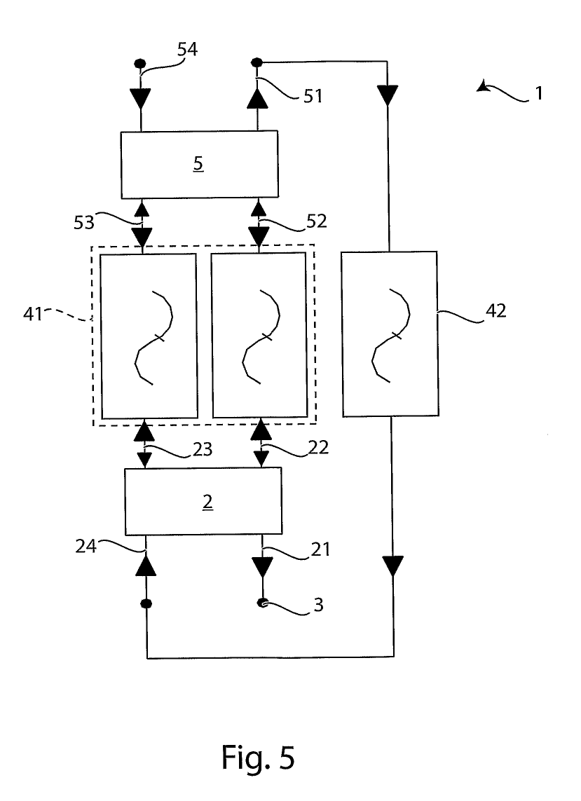

FIG. 5 shows a third embodiment of a filtering apparatus according to the invention;

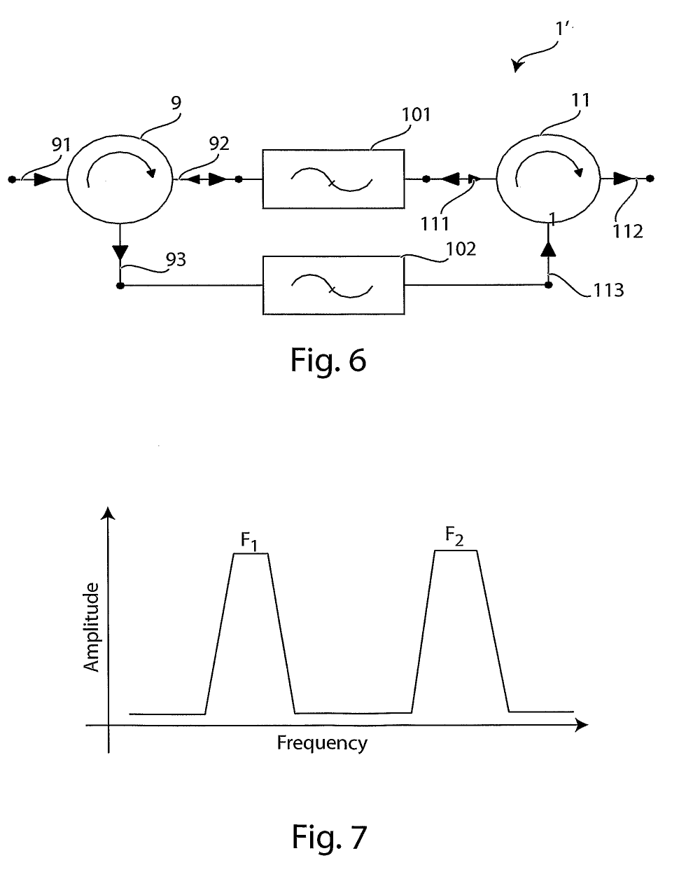

FIG. 6 shows a fourth embodiment of a filtering apparatus according to the invention;

FIG. 7 shows graph of spectrum at the outlet of filtering apparatus according to FIG. 6;

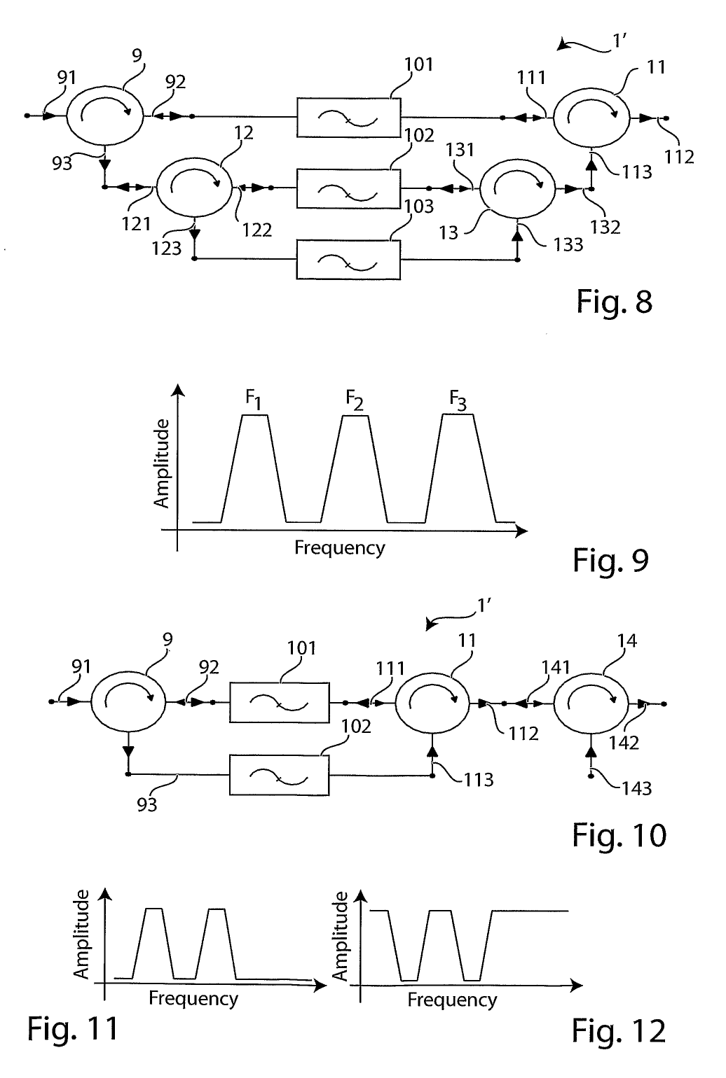

FIG. 8 shows a fifth embodiment of a filtering apparatus according to the invention;

FIG. 9 shows graph of spectrum at the outlet of filtering apparatus according to FIG. 9;

FIG. 10 shows a sixth embodiment of a filtering apparatus according to the invention;

FIG. 11 shows graph of spectrum at the outlet of filtering apparatus according to FIG. 10; and

FIG. 12 shows graph of spectrum of signal at the inlet port of outlet circulator of filtering apparatus according to FIG. 10.

Making reference to FIG. 1, it is observed a first embodiment of multiple response apparatus 1 according to the present invention.

Said apparatus 1 mainly comprises a first hybrid connection 2, having a plurality of ports, one of which is connected with the inlet connector 3 of apparatus 1, within which signal to be filtered is input. Hybrid connection 2 is connected to filtering means 4, comprised of a first filtering unit 41, comprising two identical filters 41′, 41″, and a second filtering unit 42 comprising a single filter 42′, suitable to carry out filtering operations on signal brought to their inlet; and a second hybrid connection 5, in which signals processed by said filtering means 4 are brought to the different inlets, so as to permit their spectral combination.

Analyzing more carefully this figure, it is observed that said first hybrid connection 2 is of the attenuation type at −3 dB and a rotation of 90° with respect to the phase.

Said first hybrid connection 2 has four ports, or terminals 21, 22, 23 and 24. Port 21 is the inlet port for the signal to be filtered, while ports 22 and 23 are respectively connected with filters 41′ and 41″. Finally, port 24 of said first hybrid connection 2 is connected with said filter 42.

Also second hybrid connection 5 has four ports 51, 52, 53, 54. Ports 52 and 53 are respectively connected with outlet of filters 41′ and 41″, port 51 is connected with outlet of filter 42 and port 54 is the outlet port of signal processed by apparatus 1 according to the invention, and it can be for example connected to an antenna.

It must be noted that filters 41′, 41″ and 42 can be more or less selective (it depends on the number of poles) according to the specific needing, and thus operating by every kind of processing (e.g. low-pass, band-pass, notch, . . . ).

To understand operation of the above circuit, a signal arriving from a transmitter (not shown in the figure) is placed on port 21 of said first hybrid connection 2. Said signal has a spectrum with a band extending at a first F1 and a second F2 frequency. Said signal is divided by two in its amplitude (said first hybrid connection is of the 3 dB type, thus carrying out an attenuation of −3 dB on signal amplitude A corresponding to generation of a signal A/2), while phase has a difference of 90°. Signal with attenuated and offset amplitude is thus present, due to known properties of hybrid connections, at port 22 and port 23.

No signal (insulated or mute port) would exist on the above port 24, but in case signal would be reflected both in port 22 and in port 23 (i.e. it would be at inlet of said ports). In this case, signals reflected are available at port 24.

Signals presents in ports 22 and 23 supply pair of filters 41′ and 41″ provided between the two hybrid connections.

As already said, filters employed can be of every kind. Choice is connected to the kind of required service (i.e. transfer function) (low-pass, high-pass, band-pass and band-deletion) or to signal or spectrum combination that it is wished obtaining at the outlet on port 54, as it will be better explained in the following.

In the present case, three filters employed are of the band-pass type and each one has a pre-set passing band with a central frequency F1 and F2.

Outlet of two filters 41′ and 41″, that will be a signal with a band about frequency F1 supplies port 52 and port 53 of second hybrid connection 5, combination of phases being such to sum up two signals in port 54 and insulating port 51.

As already said, transmitter transmits a signal with a spectrum extending so as to include bands about frequencies F1 and F2. First band passes through filters 41′ and 41″ between two hybrid connections 2 and 5, while remaining part of spectrum is reflected in ports 22 and 23 and is in port 24 of first hybrid connection.

Filter 42 connected to port 24 let pass second band of frequency spectrum centered on frequency F2. Outlet of filter 42 is brought again on port 51 of second hybrid connection 5 which, for remarkable properties of hybrid ports, is a “wide band” inlet.

Signal of second frequency band centered on F2 is distributed in amplitude on ports 52 and 53 of said second hybrid connection 5, with the same mode described with reference to first hybrid connection 2. Since ports 52 and 53 are connected with filters 41′ and 41″, calibrated on a central frequency F1, signal on the same is again reflected by said filters 41′ and 41″ and combined again in port 54 (phase differences are suitably compensated), of said second hybrid connection 5, along with signal with band having central frequency F1.

Signal exiting from port 54 has a spectrum as shown in FIG. 2. Spectra of the two bands centered on frequencies F1 and F2 exiting from transmitter, have been filtered by filters 41′, 41″ and 42, as requested by service to which they are destined and are present at the outlet of the apparatus 1 to supply a transmitting system (antenna or like), without any theoretical attenuation.

It must considered that among arrows shown in the figures on connections, those which are bigger are relevant to the signal direction, while those with lower dimensions are relevant to reflected signal. The abode will apply also to the following figures.

FIG. 3 shows a second embodiment of multiple response filtering apparatus 1 according to the present invention. In the present case, some variations have been made to the circuit described in the above, suitable to permit addition of a further transmission signal or spectrum.

Examining the figure, it is observed that this embodiment comprises a third and a fourth hybrid connection 6 or 7 and that second filtering unit 42 comprises two filters 42′ and 42″. Said further hybrid connections 6, 7 are of the same kind of said first and second hybrid connections 2, 5.

Port 24 of first hybrid connection 2 is connected to port 61 of said third hybrid connection 6. Remaining ports of said third hybrid connection 6 are connected as follows: port 62 and port 63 are respectively connected in inlet to filters 42′ and 42″; port 64 is connected to a dissipation resistive load 8, the operation of which will be better specified in the following.

Two filters 42′ and 42″ are respectively connected with ports 73 and 72 of the third hybrid connection 7. Finally, port 74 is connected to port 51 of said second hybrid connection 5.

Even for operation, it follows the same logic of the embodiment shown in FIG. 1. An outer complement is connected to a port 21, by connector 3, combining outlet of “N” transmitters into a single frequency spectrum.

Operator can, by apparatus 1 shown in figure, optionally inserting further transmitters, that must work in the same frequency spectrum of hybrid connections, being it available a further “wide band” inlet.

Outlet of port 54 supplies the same antenna (transmitting system) so as servicing area of new transmitters has the same covering of the first ones.

Hypothesizing that a signal is always present at inlet of port 21 of first hybrid connection, said signal being as described in embodiment of FIG. 1.

Signal modulated on band centered on said first frequency F1 is handled as described in first embodiment and is brought on port 54 of the second hybrid connection 5.

Signal comprised of spectrum reflected by filters 41′ and 41″ (i.e. without band with central frequency F1, but including band with central frequency F2) is present in port 24 of first hybrid connection 2.

Signal with band centered on F2 is brought to ports 72 and 73 by filters 42′ and 42″, while remaining part of spectrum is reflected both by first filtering unit 41 and second filtering unit 42, until finding on port 64 of fourth hybrid connection 6, to which, as already said, it is connected a suitable resistive load 8, having a value identical to the system impedance. In other words, typical value is 50 ohm for broadcasting transmitters and/or similar uses, or it is 75 ohm in cable distribution of signals (CATV).

Port 71 of fourth hybrid connection 7 is the required “wide band” inlet. In case it is not used, it is suitable using a resistive load as the one connected with port 64.

In case instead it is necessary adding one or more transmission bands, signal of third frequency spectrum including said bands is present in port 71, and thus reflected by second filtering unit 42 in port 74 of the third hybrid connection 7, to be further reflected by said first filtering unit 41, to be combined with signal containing bands centered on frequencies F1 and F2 on port 54 of the second hybrid connection 5. FIG. 4 shows spectrum of signal of port 71 (wide band inlet) wherein it is observed effect of said first and second filtering units 41 and 42.

FIG. 5 is a third embodiment of apparatus 1 according to the present invention that, as it can be clearly understood, is structurally identical to the one shown and described in FIG. 1.

Main difference of this embodiment is that apparatus 1 is connected in a reception configuration. In other words, an antenna, not shown in the figure, is connected to port 54 of said second hybrid connection 5 (it is possible connecting antenna to port 21, thus obtaining again exactly the condition of FIG. 1; it means that apparatus 1 of the first embodiment is fully reversible), said antenna acting as generator.

Obviously, operation of apparatus 1 of this embodiment is completely similar with respect to the embodiment described in FIG. 1, varying only direction of signals.

Sole limit of apparatus 1 of FIG. 5 operating under a reception mode is due to the case in which noise temperature, that is present to the receiver inlet, can be degraded due to insertion losses. In this case, in order to reduce this effect, it is possible using a different circuitry, for example replacing hybrid connections with three port elements or terminals characterized by “circulator” operation, permitting a remarkable reduction of noise.

An embodiment of an apparatus 1′ provided with circulators, particularly suitable for reception of rather weak radio signals, is shown in FIG. 6.

As it can be observed, apparatus 1′ mainly comprises a first circulator 9 provided with three ports, an inlet port 91 and two outlet ports 92 and 93, each one connected to a filter, respectively 101 and 102, and a second circulator 11 having three ports 111, 112 and 113. Ports 111 and 112 are connected at the outlet respectively to said filters 101 and 102.

According to the well known properties of circulators, they provide transmission of signal in adjacent ports following circulation arrow and another impedance following the same according to a contrary direction. therefore, for example, first circulator 9 will have a low impedance for inlet signals at port 91 toward port 92, while a high impedance will be present between port 91 toward port 93.

Thus operation of apparatus 1′ can be described as follows. A signal with a spectrum extending so as to cover a first and a second frequencies F1 and F2 is placed at the inlet of apparatus 1′ on port 91 of first circulator 9, addressing it to port 91 toward port 92, while, as already said, it has a high insulation directly from port 91 toward port 93 and from port 93 toward port 92.

Filter 101, that in the present embodiment is of the band-pass type with a central frequency F1, reflects frequency spectrum wherein the same has a high attenuation, in the present case presenting at port 93 of said first circulator 9.

A second filter 102 is connected between port 93 of the first circulator 9 and port 113 of second circulator 111, and it is tuned in the second frequency spectrum F2.

Consequence is that first frequency spectrum F1 is present in port 111 of second circulator 11, as well as second spectrum of frequencies F2 in port 113.

A frequency spectrum is present on port 112 of second circulator 11, due to bands centered on frequencies F1 and F2, i.e. tuning of filters 101 and 102, respectively. FIG. 7 shows said spectrum on port 112 of second circulator 11.

Use of this embodiment of apparatus 1′ is mainly limited by transit power. In fact, this circuitry cannot be used as the one of the first embodiment, since power of circulators cannot pass 50 W due to high manufacturing costs and to the insertion losses. Thus, use is preferably limited to receivers and low power transmitting systems.

FIGS. 8 and 9 are operatively similar to embodiment of FIG. 6. Only difference is that apparatus 1 is in this case able filtering and combining three different signals modulated on bands respectively centered on sequences F1, F2 and F3. As it is observed, system comprises three filters 101, 102 and 103, and a first circulator 9, a second circulator 11, a third circulator 12 and a fourth circulator 13.

FIG. 9 shows outlet signal on port 112 of second circulator 11.

FIG. 10 shows fifth embodiment of filtering apparatus 1′ according to the invention, corresponding to the solution comprising circulators of FIG. 3, in order to obtain a wide band inlet that can be applied both to the double spectrum system (FIG. 6) and to the triple spectrum system (FIG. 8), up to N spectra.

Circuital structure of apparatus 1′ is fully similar to the one of FIG. 6, with the sole difference that inlet port 141 of a further circulator 14 is connected to circulator port 11. Outlet of apparatus 1′ is taken on port 142 of circulator 14, while port 143 is used as required “wide band” inlet. Thus, in case there is the needing of adding one or more transmission bands, it is possible introducing them through port 143 in order to obtain them combined with the one at inlet of port 142.

FIGS. 11 and 12 respectively show graph of spectrum on terminal or port 112 and graph of spectrum of signal in inlet port or terminal 143 of combination circulator 14.

Apparatus 1 can be also used for optical fiber signals using suitable filters.

The above operation principle is not limited to the above examples, but employing suitable components, it can be used with different frequency bands, i.e. from kHz to TeraHz, including also components developed for application for optic fibers. In other words, it is possible stating that the use can be extended to all the electromagnetic fields.

The present invention has been described for illustrative but not limitative purposes, according to its preferred embodiments, but it is to be understood that modifications and/or changes can be introduced by those skilled in the art without departing from the relevant scope as defined in the enclosed claims.

1. Multiple response filtering apparatus (1; 1′) comprising:
distribution means (2, 7, 6; 9, 12), with an inlet port (21; 91) and a plurality of outlet ports (23, 22, 63; 92, 122), suitable to distribute inlet signals on at least a first assembly of said outlet ports plurality (23, 22, 63; 92, 122) and to further distribute signal arriving from said at least a first assembly on at least a second assembly of said plurality of outlet ports (23, 22, 63; 92, 122);
a plurality of filtering units (41, 42; 101, 102, 103), having first and second terminals, each filtering unit (41, 42; 101, 102, 103) being connected by said first terminals to a relevant assembly of outlet ports (23, 22, 63; 92, 122) of said distribution means (2, 7, 6; 9, 12) and suitable to carry out a filtering operation transmitting a spectrum band of a signal on said first terminals and on said second terminals and reflecting the remaining part of the spectrum, and vice versa; and
combination means (5, 7; 11, 13, 14) with a plurality of inlet ports (52, 53, 72, 73; 111, 131, 141) connected with second terminals of said filtering units (41, 42; 101, 102, 103) and an outlet port (54; 112, 141), said combination means (5, 7; 11, 13, 14) being suitable to combine on said outlet port (54; 112, 141) signal arriving from said second terminals of said filtering units (41, 42; 101, 102, 103).

2. Apparatus (1; 1′) according to claim 1, wherein said combination means (5, 7; 11, 13, 14) comprise a further inlet port (71; 143) for a further signal of a wide band signal and said combination means (5, 7; 11, 13, 14) combining said signal with said outlet signal.

3. Apparatus according to claim 1, wherein said filtering means (41, 42; 101, 102, 103) are of the low-pass and/or band-pass and/or band-deletion and/or high-pass type.

4. Apparatus according to claim 1, wherein said distribution means and said combination means comprise one or more hybrid connections (2, 6, 7), each one of said connections being provided with a first, a second, a third and a fourth terminals, so that a signal entering within said first or said fourth terminal is distributed on said second and third terminal, while a third signal entering in said second or third terminal is distributed on said fourth or first terminal.

5. Apparatus (1; 1′) according to claim 4, wherein said hybrid connections are of the attenuation type with −3 dB and 90° phase-displacement.

6. Apparatus according to claim 4, wherein said distribution means comprise hybrid connections (2, 6) in a number corresponding to the number of filtering operations minus one and having a first and a last hybrid connection, so that:
first terminal (21) of said first hybrid connection (2) is the inlet port of said apparatus (1);
second and third terminal of each hybrid connection are both connected with a relevant filtering unit (41′, 41″) for each hybrid connection; and
fourth terminal of said last hybrid connection is connected to a filtering unit (42), while fourth terminal is connected with first terminal of the following hybrid connection;
said combination means can comprise a plurality of hybrid connections (5, 7), in a number corresponding to the number of frequencies to be filtered minus one and having a further first and a further last hybrid connection, and collected in such a way that:
fourth terminal (54) of said further first hybrid connection (5) is the outlet port of said apparatus (1);
second and third terminals of each hybrid connection are both connected to a relevant filtering unit (41′, 41″, 42) for each hybrid connection; and
first terminal of said further last hybrid connection is connected with said filtering unit (42) to which fourth terminal of said last hybrid connection of said distribution means is connected, while first terminal of each possible hybrid connection is connected to the fourth terminal of the following hybrid connection.

7. Apparatus (1; 1′) according to claim 6, wherein said filtering units connected to said second and third terminals of each hybrid connection of said distribution means comprise a pair of independent filters (41′, 41″), each one connected with one of said terminals and both suitable to carry out the same filtering operation, while filtering unit connected to the fourth terminal of the past hybrid connection comprises a single filter (42).

8. Apparatus according to claim 4, wherein said distribution means comprise one or more hybrid connections (2, 6) in a number corresponding to the number of filtering operations and having a first and a last hybrid connection, connected in such a way that:
first terminal (21) of said first hybrid connection (2) is the inlet port of said apparatus (1);
fourth terminal of said last hybrid connection is connected to a resistive load (8), while fourth terminal of each one of the possible hybrid connections is connected to the first terminal of the following hybrid connection; and
second and third terminal of each hybrid connection are both connected to a relevant filtering unit (41, 42) for each hybrid connection;
said combination means comprising two or more hybrid connections in a number corresponding to the number of filtering operations, having a further first and a further last hybrid connection, and collected so that:
fourth terminal (54) of said first hybrid connection (5) is the outlet port of said apparatus(1);
first terminal (71) of said further last hybrid connection is said further inlet port for a further signal, to which it can be connected a resistive load in case it is not used, while first terminal of each hybrid connection is connected with the fourth terminal of the following hybrid connection, or with said further last hybrid connection in case two filtering operations are carried out; and
second and third terminal of each hybrid connection are both connected with a relevant filtering unit (41, 42) for each hybrid connection.

9. Apparatus (1; 1′) according to claim 8, wherein each one of said filtering units (41, 42) is connected with said second and third terminals of each hybrid connection of said distribution means, and comprises a pair of independent filters (41′, 41″, 42′, 42″), each one connected with one of said terminals and both suitable to carry out the same filtering operation.

10. Apparatus according to claim 8, wherein said resistive load (8) is of 50 ohm or 75 ohm.

11. Apparatus according to claim 1, wherein said distribution means and said combination means comprise circulators (9, 11, 12, 13, 14), each one provided with one first, a second and a third terminal placed consecutively each other.

12. Apparatus according to claim 11, wherein said distribution means can comprise one or more circulator, in a number corresponding to the number of filtering operations minus one, and having a first and a last circulator, connected in such a way that:
first terminal (91) of said first circulator (9) is the inlet port of said apparatus (1);
second terminal of each circulator is connected to a relevant filtering unit (101, 102, 103); and
third terminal of said last circulator, or of said first circulator in case of two filtering operations, is connected with a filtering unit (103), while third terminal of each other possible circulator is connected with first terminal of the following circulator;
said combination means can comprise a plurality of circulator in a number corresponding to the number of filtering operation minus one comprising a further first and a further last circulator and connected in such a way that:
first terminal of each one of said circulator is connected with a relevant filtering unit (101, 102, 103);
second terminal (112) of said further first circulator (11) is the exit port of said apparatus (1), while second terminal of each other possible circulator is connected to the third terminal of the preceding circulator;
third terminal (131) of said further last circulator (13) is connected to the exit of said filtering unit (103) at the inlet of which it is connected third terminal of said last circulator of said distribution means.

13. Apparatus (1; 1′) according to claim 12, wherein it comprises a combination circulator (14) the first terminal (141) of which is connected to the exit port of said apparatus (1) and on third terminal being it possible connecting a further signal source, so that a signal is present on the relevant second terminal (142) of said combination circulator (14), the frequency spectrum of which is combination of frequency spectrum of said signals arriving from said exit port of said apparatus (1) and from said further source.

14. Apparatus according to claim 11, wherein said filtering units comprise a single filter (101, 102, 103).

15. Apparatus according to claim 1, wherein said apparatus is connected by optic fibers.
